(19) United States
(12) Patent Application Publication
(10) Pub. No.: US 2025/0148673 A1
(43) Pub. Date: May 8, 2025

(54) METHOD, APPARATUS, ELECTRONIC DEVICE AND STORAGE MEDIUM FOR EFFECT PROCESSING

(71) Applicant: Beijing Zitiao Network Technology Co., Ltd., Beijing (CN)

(72) Inventor: Xiaogeng ZHANG, Beijing (CN)

(21) Appl. No.: 18/938,506

(22) Filed: Nov. 6, 2024

(30) Foreign Application Priority Data
Nov. 7, 2023 (CN) 202311475919.1

(51) Int. Cl. G06T 11/60; G06T 5/20; G06T 5/70; G06T 7/12; G06T 7/70

(52) U.S. Cl. CPC G06T 11/60; G06T 5/20; G06T 5/70; G06T 7/12; G06T 7/70

(57) ABSTRACT

Embodiments of the present disclosure provide a method, an apparatus, an electronic device and a storage medium for effect processing. The method comprises: in response to an effect triggering operation, obtaining a first image and a second image, wherein the first image comprises a target object, and the second image is displayed on an upper layer of the first image; determining a target image region in the second image based on the capture distance and an object position of the target object in the case where a capture distance between the target object and a capture apparatus satisfies a first distance condition; displaying at least part of an image content in the first image in the target image region to acquire an effect image.

### CROSS-REFERENCE TO RELATED APPLICATION(S)

This application claims priority to Chinese Application No. 202311475919.1 filed Nov. 7, 2023, the disclosure of which is incorporated herein by reference in its entirety.

### FIELD

Embodiments of the present disclosure relate to the field of effect processing, and more specifically, to a method, an apparatus, an electronic device and a storage medium for effect processing.

### BACKGROUND

In the scene of image processing or video production, effect props are favored by users. Users may process an image or video with a selected effect prop so that the resulting effect image exhibits an effect corresponding to the effect prop.

In the related art, when effect elements are added in an image or video, an effect image is usually acquired after adding selected effect elements on an original image including a target object. In addition, with regard to the effect processing requirement of presenting the linkage between the target object and the effect element in the effect image, the following-type effect element can be added to the target object in the original image so as to realize interaction between the effect element and the target object; alternatively, a pre-constructed interaction-type effect may be used to process the original image to enable interaction between the target object in the original image and the effect.

However, when the above first manner is used for effect processing, the display mode of the original image and the effect element is relatively fixed, and the interaction effect is single; when the second manner is used, there are some problems, such as long pre-production period, poor performance and unstable effect.

### SUMMARY

Embodiments of the present disclosure provide a method, an apparatus, an electronic device and a storage medium for effect processing. The technical solution of embodiments of the present disclosure realizes to apply a capture distance of a target object in an image to an effect processing process so as to obtain an effect of an effect image associated with the capture distance.

In a first aspect, the present disclosure provides a method for effect processing comprising:
in response to an effect triggering operation, obtaining a first image and a second image, wherein the first image comprises a target object, and the second image is displayed on an upper layer of the first image;
determining a target image region in the second image based on the capture distance and an object position of the target object in the case where a capture distance between the target object and a capture apparatus satisfies a first distance condition;
displaying at least part of an image content in the first image in the target image region to acquire an effect image.

In a second aspect, the present disclosure provides an apparatus for effect processing comprising:
an effect triggering module for acquiring a first image and a second image in response to an effect triggering operation, wherein the first image comprises a target object, and the second image is displayed on an upper layer of the first image;
an image region determination module for determining a target image region in the second image based on the capture distance and an object position of the target object in the case where a capture distance between the target object and a capture apparatus is detected to satisfy a first distance condition;
an effect image display module for displaying at least part of an image content in the first image in the target image region to acquire an effect image.

In a third aspect, the present disclosure provides electronic device comprising:
one or more processors;
a storage device for storing one or more programs,
when the one or more programs are executed by the one or more processors, causing the one or more processors to implement the method for effect processing of the embodiment of the present disclosure.

In a fourth aspect, the present disclosure provides a storage medium containing computer-executable instructions for performing the method for effect processing of the embodiment of the present disclosure.

### BRIEF DESCRIPTION OF THE DRAWINGS

Through the following detailed description with reference to the accompanying drawings, the above and other objectives, features, and advantages of example embodiments of the present disclosure will become more apparent. Throughout the drawings, the same or similar reference signs usually refer to the same or similar components. It should be understood that the drawings are diagrammatic and that elements and elements are not necessarily drawn to scale.

FIG. 1 illustrates a schematic flowchart of a method for effect processing in accordance with embodiments of the present disclosure;

FIG. 2 illustrates a schematic diagram of an effect image in accordance with embodiments of the present disclosure;

FIG. 3 illustrates a schematic flowchart of another method for effect processing in accordance with embodiments of the present disclosure;

FIG. 4 illustrates a schematic flowchart of further another method for effect processing in accordance with embodiments of the present disclosure;

FIG. 5 illustrates a schematic diagram of a structure of an apparatus for effect processing in accordance with embodiments of the present disclosure;

FIG. 6 illustrates a schematic diagram of a structure of an electronic device in accordance with embodiments of the present disclosure;

### DETAILED DESCRIPTION OF EMBODIMENTS

Embodiments of the present disclosure will be described in more details below with reference to the drawings. Although the drawings illustrate preferred embodiments of the present disclosure, it should be appreciated that the present disclosure can be implemented in various manners and should not be limited to the embodiments explained herein. On the contrary, the embodiments are provided to make the present disclosure more thorough and complete and to fully convey the scope of the present disclosure to those skilled in the art. It should be understood that the drawings and Embodiments of the present disclosure are for illustrative purposes only and are not intended to limit the scope of the present disclosure.

It should be understood that the various steps recited in the method embodiments of the present disclosure may be performed in a different order and/or in parallel. Moreover, method embodiments may include additional steps and/or omit performing the steps shown. The scope of the present disclosure is not limited in this respect.

As used herein, the term “includes” and its variants are to be read as open-ended terms that mean “includes, but is not limited to.” The term “based on” is to be read as “based at least in part on.” The terms “one embodiment” is to be read as “at least one example embodiment.” The term “a further embodiment” is to be read as “at least a further embodiment.” The term “some embodiments” is to be read as “at least some embodiments”. Relevant definitions of other terms will be given in the following description.

It should be noted that references to “first”, “second”, and the like in the present disclosure are only used to distinguish different devices, modules, or units and are not intended to limit the order or interdependence of the functions performed by the devices, modules, or units.

It is noted that the modifications referred to “a” and “some” throughout the present disclosure are intended to be illustrative and not restrictive, and those skilled in the art will understand that “one or more” is to be interpreted unless the context clearly indicates otherwise.

The names of messages or information interacted between devices in embodiments of the present disclosure are for illustrative purposes only and are not intended to limit the scope of such messages or information.

It should be understood that prior to using the technical solutions disclosed in the various embodiments of the present disclosure, the user should be informed of the type, scope of use, use scenario, etc. concerning personal information involved in the present disclosure and be authorized by the user in an appropriate manner according to relevant laws and regulations.

For example, in response to receiving a user's active request, prompt information is sent to the user to explicitly prompt the user that the operation requested to be performed will require acquiring and using personal information to the user. Accordingly, a user can autonomously select whether to provide personal information to software or hardware, such as an electronic device, an application program, a server or a storage medium, which executes the operation of the technical solution of the present disclosure, according to prompt information.

As an alternative but non-limiting implementation, in response to receiving an active request from a user, the prompt message may be sent to the user, for example, in the form of a pop-up window in which the prompt message may be presented in text. In addition, the pop-up window may also carry a selection control for the user to select “agree” or “disagree” to provide personal information to the electronic device.

It is to be understood that the above-described notifying and acquiring user authorization processes are merely illustrative and not limiting of implementations of the present disclosure, and that other ways of satisfying relevant laws and regulations may also be applied to implementations of the present disclosure.

It is understood that the data involved in this technical solution (including but not limited to the data itself and the acquisition or use of the data) shall comply with the requirements of relevant laws and regulations and relevant provisions.

Before introducing the present solution, an application scenario may be exemplified. The technical solution can be applied to any scene that needs to generate effect images or effect videos. Illustratively, when a user uploads a recorded multimedia data stream to a service end corresponding to an application, or acquires a video image in real time via a mobile terminal comprising a capture apparatus, the video image can be processed based on the triggered selected effect prop. In the case where the triggered and selected effect props are interactive effect props and show effect related to a brush, when effect processing is performed, a three-dimensional model corresponding to the effect props is usually pre-constructed, and then interaction with a user is realized based on the three-dimensional model. Furthermore, when using a brush to draw, a fixed brush or an optional brush is usually used to perform effect processing on an image or video so as to acquire an effect image. However, the effect props used in this effect processing manner have a long preparation period, poor performance and unstable effect treatment effect. Also, interaction between the brush effect and the user cannot be linked to the user's body, resulting in low interest and poor interaction.

At this time, according to the technical solution of the embodiment of the present disclosure, when performing effect processing, a first image including a target object and a second image displayed on an upper layer of the first image may be acquired. Further, in the case where the capture distance between the target object and the capture apparatus in the first image satisfies the first distance condition, a target image region in the second image is determined based on the capture distance and the object position of the target object; further, at least part of the image content in the first image may be displayed in the target image region, to acquire an effect image. Thus, the capture distance of the target object in the image is applied to the effect processing to acquire the effect of the effect image correlated with the capture distance, increasing the interaction between the user and the effect props, enhancing the richness and interest of the effect image, and improving the user's experience of using the effect props.

Before introducing the present technical solution, it should be noted that the apparatus for executing the effect processing method provided by the embodiments of the present disclosure can be integrated in application software supporting the effect processing function, and the software can be installed in an electronic device, and alternatively, the electronic device can be a mobile terminal or a PC. The application software can be a kind of software for image/video/word processing, and the specific application software thereof will not be described in detail herein, as long as the image/video/word processing can be implemented. It can also be a specially developed application program and integrated in the software for implementing effect processing, or integrated in the corresponding page, and the user can implement effect processing through the integrated page on a PC.

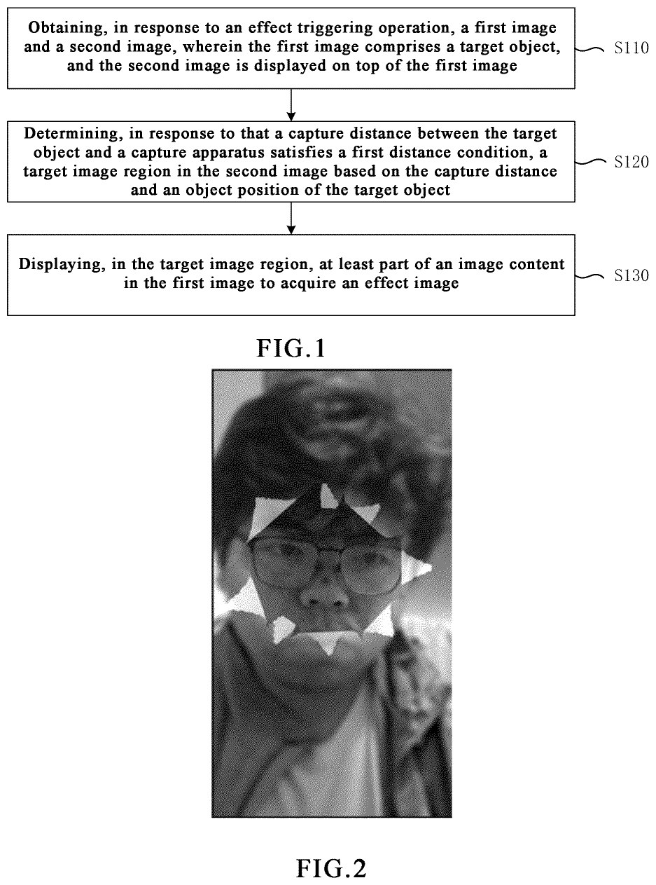

FIG. 1 illustrates a schematic diagram of a method for effect processing in accordance with embodiments of the present disclosure. The embodiment of the present disclosure is applicable to the case where an acquired image is processed based on application software so as to generate an effect image, for example, the case where a first image including a target object and a second image displayed on an upper layer of an original image can be processed so as to generate an effect image in which at least part of the content in the first image is displayed in an image region in the second image. The method can be executed by an apparatus for effect processing, and the apparatus can be realized in the form of software and/or hardware; and alternatively, this is achieved by means of an electronic device which may be a mobile terminal, a PC or a server etc.

As shown in FIG. 1, the method of the present embodiment may specifically include:

S110, in response to an effect triggering operation, obtaining a first image and a second image, wherein the first image comprises a target object, and the second image is displayed on an upper layer of the first image;

In the present embodiment, the effect triggering operation can be understood as an operation of executing an image effect processing flow after triggering. Generally, a control capable of triggering an effect can be preset in an application software or an application program supporting an effect processing function. Further, in the case where the control is triggered by the user, a triggering operation may be responded to. Thus, the first image and the second image are obtained.

It should be noted that the technical solution of the present embodiment can be executed in the process of a user shooting a video, namely, generating an effect video in real time according to an effect selected by the user and the shot video, or taking a video uploaded by the user as an original data basis, and then generating an effect video based on the solution of the present embodiment.

In practice, the first image and the second image may be obtained only in the case where certain effect are triggered. Alternatively, the specific effect triggering operation may comprise at least one of: triggering effect props; audio information triggering effect wakeup words; the current limb movement being consistent with the preset limb movement.

The first image may be an image requiring effect processing. Alternatively, the first image may be an image collected on the basis of the terminal device, or may be an image randomly or selectively called from an image pre-stored in a storage space of application software (such as an image library) or a storage space of the terminal device (such as a local photo album), or may also be an image received and transmitted by an external device, etc. and the embodiments of the present disclosure are not particularly limited thereto. Alternatively, the terminal device may refer to an electronic device having an image capturing function such as a camera, a smart phone, and a tablet computer. In this embodiment, the target object is included in the first image. The target object can be understood as an object in an image that interacts with a triggered effect prop. Note that one or more objects may be included in the first image. In the case where one object is included in the first image, the object may be taken as the target object. In the case where a plurality of objects are included in the first image, there may be a number of ways to determine the target object, alternatively, in response to a selection triggering operation on the objects included in the image, the target object is determined; alternatively, the first image is processed based on a preset target object detection algorithm, and the object in the first image is detected, and the detected object is taken as the target object. The target object may be any type of object. Alternatively, the target object may be one or more of a person, an animal, or a building. Meanwhile, the number of target objects can be one or more, and whether one or more, the technical solution provided by the embodiments of the present disclosure can be used to perform effect processing.

Here, the second image may be understood as an image for being displayed on the upper layer of the first image. The second image may also be understood to be an image that can have a certain masking effect on the first image. It should be noted that the second image may be an unprocessed original image or an image acquired after processing any image by the preset image processing manner. The embodiments of the present disclosure do not specifically limit this. In practical applications, there may be a plurality of acquiring methods for the second image, and these acquisition methods are described separately below.

First: a preset image is obtained as the second image.

In this embodiment, the preset image may be the preset image and can be displayed on the upper layer of the first image. It should be noted that the preset image may be a default template image; or, may be an image collected by a terminal device; or, may be an image acquired from a target storage space (such as an image library of application software, or a local terminal photo album, etc.) in response to a selection triggering operation of a user; or, may be an image uploaded and received by an external device, etc. Illustratively, the preset image may be an image with at least part of white region; alternatively, it may be an image comprising an animated cartoon character.

In practical applications, in the case where an effect triggering operation is detected, the effect triggering operation can be responded to. Further, the first image and the preset image may be obtained, and the obtained preset image may be taken as the second image. Thus, the first image and the second image can be obtained.

Second: the first image is processed based on the preset image processing manner to obtained the second image.

The image processing manner comprises at least one of adding a grey filter, blurring processing, binarization processing and stylization processing.

As will be appreciated by those skilled in the art, a filter refers to applying a particular image processing algorithm to an original image to change various attributes of the original image, such as color, brightness, contrast, saturation, etc. In the present embodiment, performing the gray filter processing on the first image may be understood as changing various attributes of the first image, such as color, brightness, and contrast, so that the color presented by the processed first image is gray. Note that the image processing algorithm applied by the filter processing may be a Look Up Table (LUT). The principle of the LUT refers to look up a mapped color thereof through a color, which can be understood as a function LUT (R1, G1, B1), a function with three independent variables of R, G and B, and the function outputs corresponding mapped values R2, G2 and B2 to achieve the effect of changing the exposure and color of a picture.

Here, the blurring processing may be understood as a process of processing the first image based on a preset blurring processing algorithm to erase noise information in the first image. In image processing, the process of denoising is a blurring processing. The preset blurring algorithm may be any blurring algorithm, alternatively, Gaussian Blur. Those skilled in the art will appreciate that Gaussian Blur, also known as Gaussian smoothing, Gaussian filtering, can generally be used to reduce image noise and reduce the level of detail, and can also be used to blur images. Generally speaking, Gaussian Blur is a process of performing weighted average on the whole image, and the pixel value of each pixel point in a Gaussian Blur image is acquired by performing weighted average on itself and other pixel values in the field.

Here, the binarization processing can be understood as a process of image segmentation, namely, adjusting a pixel value of a pixel point corresponding to a target object in a first image to a first preset pixel value, and adjusting a pixel value of a pixel point of other regions in the first image except for the target object to a second preset pixel value, so as to acquire a binarized image corresponding to the first image. The binarized image may be referred to as a mask image. The first preset pixel value may be any value, optionally 1. The second preset pixel value may also be any value, and optionally 0. Note that the first preset pixel value and the second preset pixel value are different pixel values, so that the target object in the first image can be distinguished.

Here, the stylization processing can be understood as a process of performing effect processing on the first image based on the preset stylization type so that the processed first image exhibits an effect corresponding to the preset stylization type. Alternatively, the preset stylization types may include, but are not limited to, a Picasso style, a Van Gogh style, an ink-wash style type, a geometric style type, and a cyberpunk style.

In practical applications, in the case where an effect triggering operation is detected, the effect triggering operation can be responded to. Further, a first image may be obtained. Thereafter, before the first image is processed, the first image may be retained, then the first image is processed based on the preset image processing manner, and the processed first image is taken as the second image. Accordingly, the first image and the second image are obtained.

Further, the second image may be displayed on the upper layer of the first image such that the resulting image exhibits the effect that at least part of the region of the first image is covered by the second image.

It should be noted that when the first image is processed based on the preset image processing manner, one or more image processing manners may be used to process the first image and obtain the second image, and the embodiments of the present disclosure are not particularly limited thereto.

It should also be noted that, in addition to the above-mentioned two ways of acquiring the second image, other ways of acquiring the second image satisfying specific processing requirements may also be used, and the embodiments of the present disclosure are not particularly limited thereto.

S120 determining a target image region in the second image based on the capture distance and an object position of the target object in the case where a capture distance between the target object and a capture apparatus satisfies a first distance condition;

Here, the capture apparatus may be understood as an electronic device having an image capture function. In this embodiment, the capture apparatus may be an apparatus that includes a target object within its field of view. Alternatively, the capture apparatus may be a smart phone, a tablet computer, a personal computer, etc. The capture distance can be understood as the distance between the target object and the capture apparatus; alternatively, the distance between the target point in the target object and the capture apparatus. The first distance condition may be understood as a preset effect processing triggering condition. The first distance condition may include any condition set according to the capture distance. Alternatively, the first distance condition may include a first capture distance range; alternatively, the first distance variation range. The first capture distance range can be understood as a preset capture distance interval. The first distance variation range may be understood as a preset capture distance variation interval. The object position of the target object may be determined based on the corresponding position coordinate information of the target object in the world coordinate system. The capture distance between the target object and the capture apparatus may be a depth value in the corresponding position coordinate information of the target object in the world coordinate system.

It should be noted that, in general, the area occupied by the target object included in the first image in the image is relatively large, and a relatively precise position coordinate information cannot be accurately acquired when the object position of the target object is determined. Therefore, before determining the target image region in the second image on the basis of the object position and the capture distance of the target object, the object position may also be determined according to the positions where the corresponding plurality of pixel points in the target object are located.

Alternatively, before the target image region in the second image is determined based on the capture distance and the object position of the target object, it includes acquiring a position where a target point of a target object is located as the object position is further comprised.

In this embodiment, the target point may be an arbitrary point on the target object, and the point may be a point that appears within the capture field of view of the capture apparatus. Alternatively, the target points include preset points and/or geometric center points. The preset point may be a pixel point corresponding to any location on the target object. Illustratively, the preset point may be a nose tip point. The geometric center point may be a pixel point corresponding to a geometric center of the target object, and the geometric center may be determined based on a portion of the target object that appears within the capture field of view. Illustratively, if the target object is a person and the portion of the object appearing in the photographic field of view is the head of the person, the geometric center point may be a pixel point corresponding to the geometric center of the head of the person.

In a practical application, in the case where a capture distance between the target object and the capture apparatus satisfies the first distance condition, the position where the target point of the target object is located can be acquired. Further, this position may be taken as the object position of the target object.

In practice, after acquiring the first image and the second image, the capture distance between the target object included in the first image and the capture apparatus may be continuously or periodically detected to determine whether the capture distance satisfies the first distance condition. Further, in the case where it is detected that the capture distance satisfies the first distance condition, the capture distance may be acquired. Also, the position of the object to which the target object corresponds in the present case can be determined. Thereafter, a pixel point in the second image corresponding to the object position may be determined based on the object position of the target object in the first image, and the pixel point may be taken as the region center point. Thereafter, a region parameter including at least an region size may be determined according to the capture distance. Further, a region may be constructed based on the region center point and the region parameters, and a region mask image including the region may be generated. The pixel value of the pixel point corresponding to the region in the region mask image is a first preset pixel value, and the pixel value of the pixel point corresponding to other regions except the region is a second preset pixel value. Furthermore, the pixel values of corresponding pixel points of the region mask image and the second image may be mixed, i.e. a target image region in the second image may be determined.

Note that the region style of the target image region may include at least one. In the case where the region style includes one, the region style may be taken as the region style of the target image region. In the case where a plurality of region styles are included, a target region style may be determined among the region styles based on a preset region style determination manner, and the target region style may be taken as a region style corresponding to a target image region. The preset region style determination manner may comprise various methods, for example, random determination; determining based on historical application data (e.g. historical selection frequency, etc.) corresponding to each region style; responding to the selection triggering operation for the region style, and taking the region style corresponding to the selection triggering operation as the region style corresponding to the target image region, etc.

S130, displaying at least part of an image content in the first image in the target image region to acquire an effect image.

In this embodiment, after the target image region in the second image is determined, at least part of the image in the first image can be displayed in the target image region to acquire an effect image.

At least part of the image content may be understood to be any part of the image content or all of the image content comprised in the first image. It should be noted that at least part of the image content may be the image content in the image region corresponding to the target image region in the first image; alternatively, may be an image content in another region in the first image; alternatively, the entire image content in the first image, etc., and the embodiments of the present disclosure are not particularly limited thereto. The effect image can be an image acquired after the second image and the first image are mixed with each other, that is to say, a target image region in the second image displays at least part of the content in the first image, and the image content in other image regions in the second image remains unchanged, i.e. an image can be acquired, and the image can be an effect image.

It is noted that the second image is an image comprising the complete image content, and further that the target image region in the second image also comprises the corresponding image content. Further, when at least part of the content in the first image is displayed in the target image region, the image content may be overlapped. Therefore, in order to achieve the effect of displaying only at least part of the content in the first image in the target image region such that the resulting effect image exhibits an effect closer to the real world effect, the target image region in the second image may be processed such that the image content in the second image is not displayed in the target image region. Further, at least part of the content in the first image may be displayed in the target image region.

Alternatively, displaying at least part of the image content in the first image in the target image region includes: erasing the image content in the target image region in the second image to display at least part of the image content in the first image in the target image region.

In the present embodiment, the erasing of the image content in the target image region in the second image may include various implementation methods, for example, processing the second image based on the preset image erasing algorithm so as to remove the image content in the target image region; alternatively, the operation is triggered in response to the selection of the target content in the target image region and the selected image content is erased, etc.

In practice, after the target image region is determined, the second image may be processed to remove the image content in the target image region in the second image. Further, it is possible to obtain the second image in which the target image region does not display any image content. Further, at least part of the content in the first image may be displayed in the target image region in the second image. Thus, an effect image can be acquired.

Illustratively, in the case where at least part of the image content is the image content in an image region in the first image corresponding to the target image region, after the part of the image content is displayed in the target image region, the resulting effect image may exhibit effect that the target object in the first image “punctures” the second image and “comes out” of the target image region.

In practical applications, in order to enrich the effect presented by the effect image, a region edge effect can also be added to an image edge of the target image region, so that the resulting target image edge can present the effect including the region edge effect.

Alternatively, displaying at least part of the image content in the first image in the target image region includes: determining a region edge effect corresponding to the target image region, applying the region edge effect to the target image region, and displaying at least part of the image content in the first image in the target image region.

The region edge effect can be understood as effect for acting on the region edge of any image region. In the present embodiment, the region edge effect may be associated with the region style and/or the region size of the target image region, that is, the edge style of the region edge effect may be associated with the region style of the target image region; and/or, an edge parameter of the region edge effect may be associated with a region parameter (e.g. region size and/or region shape) of the target image region.

In practical applications, when a region edge effect corresponding to a target image region is determined, a region style corresponding to the target image region may be determined, and at least one edge style associated with the region style may be determined from a plurality of candidate edge styles set in advance according to the region style. Furthermore, a target edge pattern can be determined from at least one edge pattern according to a preset edge pattern determination manner, and this target edge pattern can be used as an edge pattern corresponding to a region edge effect. Further, a region parameter of the target image region may be determined, and an edge parameter corresponding to the region edge effect may be determined according to the region parameter. Then, the region edge effect corresponding to the target image region can be determined according to the edge pattern and the edge parameters.

Further, by applying the region edge effect to the target image region, the target image region exhibiting the region edge effect can be acquired. Thereafter, at least part of the content in the first image may be displayed in the target image region, resulting in an effect image. Illustratively, with continued reference to the above example, assuming that the region edge effect is a shredded paper edge effect, the effect exhibited by the target image region acquired after applying the region edge effect to the target image region may be a region that is punctured and includes a shredded paper edge. Furthermore, after at least part of the content in the first image is displayed in the target image region, the acquired effect image can be that the target object in the first image “punctures” the second image and “comes out” of the target image region, and the target image region edge presents an effect image of a shredded paper edge effect, for example, as shown in FIG. 2, a schematic diagram of an effect image.

According to the technical solution of the embodiments of the present disclosure, the first image and the second image are obtained in response to an effect triggering operation, and since the second image is displayed on the upper layer of the first image, compared with the method of directly displaying the first image, the image display content before effect processing is enriched. Furthermore, in the case where it is detected that a capture distance between a target object in the first image and a capture apparatus satisfies a first distance condition, a target image region in the second image is determined based on the capture distance and the object position of the target object, and the feature of the target object in the depth direction is applied to the effect processing through the capture distance, and the target image region is associated with the object position of the target object, enriching the effect of the basic support data of the effect processing. Finally, at least part of an image content in the first image is displayed in the target image region to acquire an effect image, which solves the technical problems in the related art, such as the single interaction mode of the effect props and the cumbersome manufacturing process, achieves applying the capture distance of the target object in the image to the effect processing to acquire the effect of effect image associating with the capture distance, increases the interaction between users and effect props, improves the richness and interest of effect images, and enhances the use experience of effect props.

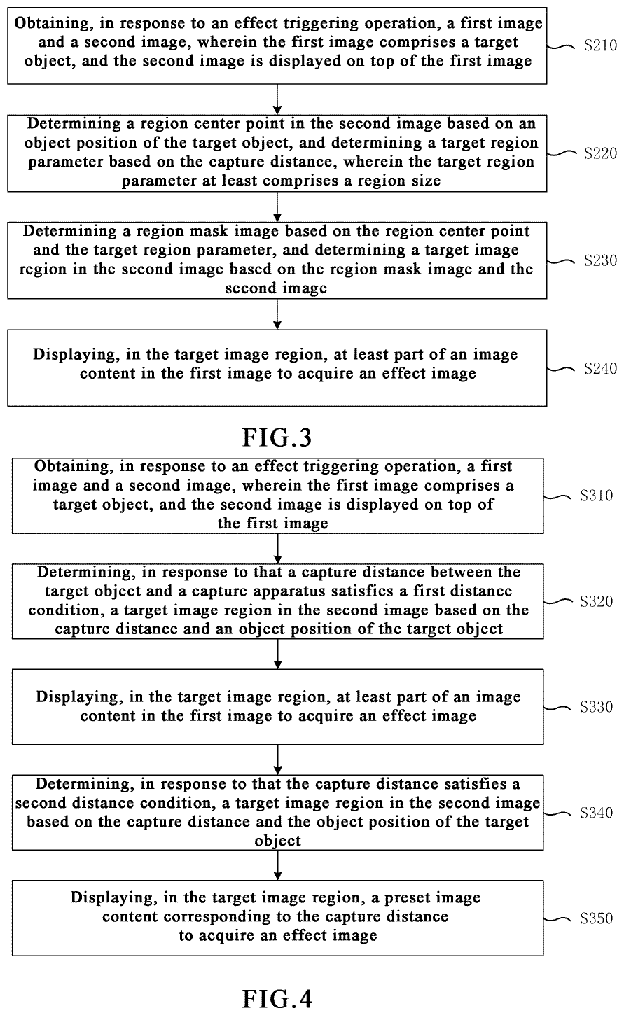

FIG. 3 illustrates a schematic diagram of another method for effect processing in accordance with embodiments of the present disclosure. In the technical solution of the present embodiment, on the basis of the above-described embodiment, an region center point is determined based on the object position of a target object, and a target region parameter is determined based on a capture distance. Further, a target image region in the second image may be determined based on the region center point, the target region parameter, and the second image. Here, the same or similar technical features to those of the previous embodiments will not be described again.

As shown in FIG. 3, the method of the present embodiment may specifically include:
S210, acquiring the first image and the second image in response to an effect triggering operation, wherein the first image comprises a target object, and the second image is displayed on an upper layer of the first image.
S220, determining a target image region in the second image based on the capture distance and the object position of the target object in the case where a capture distance between the target object and a capture apparatus is detected to satisfy a first distance condition.

The region center point can be understood as a pixel point corresponding to the center of the target image region to be constructed. The target region parameter can be understood as a parameter upon which the target image region is constructed. The target region parameter may be a parameter for indicating a region display characteristic of the target image region. The target region parameters may include a variety of parameters representing the region display characteristic. Alternatively, the target region parameters include at least a region size, and may also include a region shape or a region style, etc.

In a practical application, in the case where it is detected that the capture distance between the target object and the capture apparatus satisfies the first distance condition, the object position of the target object in this case may be determined. Further, a pixel point corresponding to the object position in the second image may be determined, and the pixel point may be taken as the region center point. Further, the capture distance in this case may be acquired, and the region size may be determined according to the capture distance, and when the region size is determined, a region style and/or a region shape corresponding to the target image region may also be determined. Furthermore, the determined region size, region style and/or region shape are taken as target region parameters corresponding to the target image region.

In practice, one or more region styles may be preset and deployed in the application software. In the case where one region style is preset, the region style may be used as the region style corresponding to the target image region. In the case where a plurality of preset region styles are preset, there may be a plurality of determination manners for the region style, for example, random determination; or, determination based on historical application data (such as historical selection frequency or region style preference index value) corresponding to each region style; alternatively, in response to the selection triggering operation for the region style, the selected region style is taken as the region style corresponding to the target image region.

Alternatively, in the case where the determination of the region style is in response to the selection triggering operation of the region style identifier, the determination process of the target region parameter may be: in response to a region setting triggering operation, displaying at least one candidate region style identifier; in response to the selection triggering operation for the region style identifier input, the target region parameter is determined based on the region style corresponding to the selected region style identifier and the capture distance.

In this embodiment, the region setting triggering operation can be understood as an operation capable of setting the target image region after triggering. Alternatively, the region setting triggering operation may include a triggering operation for a region setting control, an operation to receive a region setting instruction, or other operation capable of implementing a region setting procedure triggering, etc. Illustratively, the region setting controls may be set in advance in the effect processing interface. Further, in the case where a triggering operation for the control is detected, it is determined that a region setting triggering operation is detected. Further, at least one candidate region style identifier may be displayed in response to the region setting triggering operation.

Here, the region style identifier may be understood as an identification for identifying a region style. The region style identifier may be in various forms. Alternatively, the region style identifier may include a textual identification and/or a graphical identification. The text identification may be a name of a region style. The graphical identifier may be an image acquired by graphically displaying a region style. In this embodiment, at least one region style may be set in advance, and the region style identifier corresponding to each region style may be determined separately. Then, the region style identifier is associated with the region style, and the region style is stored in the material library of the application software, so that when a triggering operation for the region style identifier is detected, a corresponding region style can be called according to the selected region style identifier.

In a practical application, in the case of detecting a region setting triggering operation, at least one candidate region style identifier may be displayed in response to the region setting triggering operation. Further, in response to the selection triggering operation for the region style identifier input, the target region parameter is determined based on the region style corresponding to the selected region style identifier and the capture distance.

In this embodiment, the region style identifier may be set to be in the selectable state in advance. Furthermore, in the case where the region style identifier is a selected region style identifier, subsequent processing may be performed on the region style identifier. Note that the selection triggering operation for the region style identifier input may correspond to various implementations, and may optionally be a click operation for the element identification. The click operation can be a single click operation or multiple click operations (such as a double click operation, etc.); alternatively, in order to facilitate the user's operation, the region style identifier may be taken as the selected region style identifier in the case where the user pauses on the region style identifier based on the input device or the touch control point for a preset duration.

Furthermore, after the selected region style identifier is determined, a region style corresponding to the region style identifier can be called according to the region style identifier and a pre-established association relationship of the style identifiers. Further, the region size determined based on the capture distance and the determined region style may be used as the target region parameter. The advantages of such setting is that the interaction between users and effect processing is improved, the matching degree between effect image and user effect processing requirements is increased, and the interest of effect props is enhanced.

S230 determining the region mask image based on the region center point and the target region parameter, and determining the target image region in the second image based on the region mask image and the second image.

Here, the region mask image may be an image characterizing a region contour of an image region, or may be an image generated by using the image region as a target region. In general, the mask image may be a binarized image composed of two different pixel values. In practical applications, the region mask image can be acquired by adjusting a pixel value of a pixel point of an image region to a first preset pixel value, and adjusting a pixel value of a pixel point other than the image region to a second preset pixel value. It should be noted that the first preset pixel value and the second preset pixel value are two different pixel values so that the image region can be distinguished from the image.

In practice, after the region center point and the target region parameters are determined, an image region may be initially constructed based on the region center point and the target region parameters. Further, the pixel values of the pixel points of the image region in the image and the pixel values of the pixel points of the image other than the image region may be adjusted to different pixel values to distinguish the image region from the image. Further, the image in which the pixel values are adjusted may be used as the region mask effect. Thereafter, the region mask image and the second image may be subjected to an image blending process or a layer blending process, that is, the pixel values of the corresponding pixel points in the region mask image and the second image are processed. Furthermore, a target image region in the second image can be determined according to the processed image, namely, the position of the region mask in the region mask effect is the position of the target image region in the second image.

S240, displaying at least part of an image content in the first image in the target image region to acquire an effect image.

In practical applications, a target image region of the same region style may correspond to at least one region edge effect, and a target region parameter of the target image region also corresponds to an edge parameter of the region edge effect. In order to make the matching between the target region edge and the region edge effect more better, and the joining effect between the region edge effect and the target image edge more fluent, at least one the region edge effect corresponding to the region style of the target image region can be determined, and furthermore, the edge parameter of the region edge effect can be determined according to the target region parameter of the target image region. Thus, a region edge effect corresponding to a target image region can be determined.

Alternatively, determining the region edge effect corresponding to the target image region includes: displaying at least one candidate edge effect identifier in response to an edge setting triggering operation; in response to a selection triggering operation for the edge effect identifier input, determining a region edge effect corresponding to the target image region based on the target region parameter corresponding to the target image region and the region edge effect corresponding to the selected edge effect identifier.

In the present embodiment, the edge effect identifier may be an identification for identifying a region edge effect. The edge effect identifier may include various forms of identification information. Alternatively, the edge effect identifier may include textual indicia and/or graphical indicia. Here the text mark may be a name of a region edge effect. The graphical identifier may be an image acquired by graphically displaying a region edge effect. In the present embodiment, the region edge effect may be set in association with the region style in order to make the effect presented after the region edge effect acts on the target image edge more realistic and free from any discomfort. In practical applications, after at least one region style is preset, for each region style, at least one region edge effect can be set for the region style, and an edge effect identifier corresponding to each region edge effect is respectively determined. Then, the region edge effect can be associated with the region style, and the edge effect identifier can be associated with the region edge effect, and the region edge effect can be stored in the material library of the application software, so that when a triggering operation for the edge effect identifier is detected, a corresponding region edge effect can be called from the material library according to the selected edge effect identifier and a preset association relationship.

In practical applications, in the case of detecting a region setting triggering operation, the region setting triggering operation can be responded to and a region style corresponding to a target image region can be determined. Furthermore, according to the region style and the pre-established association relationship, at least one region edge effect corresponding to the region style may be determined, and an edge effect identifier corresponding to each region edge effect may be determined, and these edge effect identifiers may be taken as candidate edge effect identifiers, and the candidate edge effect identifiers may be displayed in a corresponding interface. Further, in the case where a selection triggering operation for an edge effect identifier input is detected, the selection triggering operation can be responded to and a selected edge effect identifier can be determined. Furthermore, a region edge effect corresponding to the edge effect identifier can be called, and the region edge effect can be processed according to a target region parameter corresponding to the target image region so as to make the processed region edge effect more matched with the target image region. Thus, a region edge effect corresponding to the target image region can be acquired.

Note that, upon selecting the region edge effect corresponding to the region style, random selection may be included in addition to the above-mentioned user-based selection triggering operation. Illustratively, in the case where a region setting triggering operation is detected, the region setting triggering operation is responded to. Further, a region edge effect is randomly determined from the preset at least one region edge effect, and the region edge effect is taken as the selected region edge effect. Alternatively, determination can be made based on historical application data of each region edge effect.

In a practical application, in order to enrich the display effect of the target image edge so that the edge effect of the target image edge is more realistic, a region edge effect corresponding to the target image edge can be determined, and the determined region edge effect is applied to the target image edge, and at least part of the image content in the first image is displayed in the target image region. When the region edge effect is applied to the target image edge, a mask image corresponding to the region edge effect may be determined. Furthermore, the mask image and the region mask image may be subjected to image fusion to acquire the region mask image with a region edge effect added. Furthermore, the region mask image, the second image and the first image can be subjected to image fusion, and an image in which at least part of the image content in the first image is displayed in the target image region can be acquired, i.e., an effect image.

Alternatively, on the basis of the above-mentioned technical solutions, applying the region edge effect to the target image region and displaying at least part of the image content in the first image in the target image region includes: acquiring an edge mask image corresponding to a region edge effect, and determining an effect image on the basis of the edge mask image, the region mask image, the second image and the first image. With this technical solution, an effect image can be generated simply and quickly by mixing multiple images.

Here, the edge mask image may be an image characterizing a general outline of a region edge effect, or an image generated by taking a graphical display region of the region edge effect as a target region. In practical applications, an edge mask image can be acquired by adjusting a pixel value of a graphical display region corresponding to a region edge effect to a first preset pixel value, and adjusting a pixel value other than the graphical display region to a second preset pixel value.

In practice, after determining the region edge effect corresponding to the target image edge, an edge mask image corresponding to the region edge effect may be generated. Furthermore, image blending processing can be performed on the edge mask image, the region mask image corresponding to the target image edge, the second image and the first image, so that the edge mask image, the region mask image, the second image and the first image are blended together in a layer blending manner, and pixel values of pixel points at the same position in each image are processed. Furthermore, an effect image can be acquired.

In the effect processing, the capture distance between the target object and the capture apparatus may change all the time, and accordingly, the display position and the region size of the target image region may also change, and the display position of the region edge effect acting on the target image region may change as well. Since the region edge effect is applied to the target image edge by performing image mixing processing on the edge mask image and the region mask image, namely, the region edge effect and the target image region are two pieces of information independent from each other, in the process of changing the capture distance, it may occur that the region edge effect in the previous frame of the effect image appears in the target image region in the current frame of the effect image. In order to make the image content at the position of the target image region in each frame of the effect image be the image content in the first image, the region mask effect may be arranged on the upper layer of the edge mask image when performing the image mixing process. Thus, the region edge effect can be always displayed at the target image region edge.

Alternatively, the region edge effect corresponding to the current frame may be an effect acquired by superimposing the region edge effect corresponding to the image frame located before the current frame. Accordingly, the target display region corresponding to the current frame may be an area acquired by superimposing the target display region corresponding to the image frame located before the current frame.

It should also be noted that the first image, the second image, the target image region and the region edge effect in different situations may correspond to different image blending modes and image blending orders, and the embodiments of the present disclosure are not particularly limited thereto. Illustratively, the region mask image, the edge mask image, the second image, and the first image may be layer blended in a layer-by-layer manner to acquire an effect image.

A technical solution of an embodiment of the present disclosure, the first image and the second image are acquired in response to an effect triggering operation, wherein the first image comprises a target object, and the second image is displayed on an upper layer of the first image, and further, in the case where it is detected that a capture distance between the target object and a capture apparatus satisfies a first distance condition, an region center point in the second image is determined based on the object position of the target object and a target region parameter is determined based on the capture distance, and then an region mask effect is determined based on the region center point and the target region parameter, and a target image region in the second image is determined based on the region mask image and the second image, and finally, at least part of the image content in the first image is displayed in the target image region to acquire an effect image. In such manner, the effect of applying the object position and capture distance of the target object to the effect processing process is achieved, the interaction degree between the target object and the effect prop is increased, and the interest of the effect prop in enhanced.

FIG. 4 illustrates a schematic diagram of further another method for effect processing in accordance with embodiments of the present disclosure. On the basis of the above-mentioned embodiments, after the first image and the second image are acquired, in the case where it is detected that the capture distance satisfies the second distance condition, the technical solution of the present embodiment can determine the target image region, and display the preset image content in the target image region to acquire the effect image. Here, the same or similar technical features to those of the previous embodiments will not be described again.

As shown in FIG. 4, the method of the present embodiment may specifically include:
S310, in response to an effect triggering operation, obtaining the first image and the second image, wherein the first image includes a target object, and the second image is displayed on an upper layer of the first image.
S320, determining a target image region in the second image based on the capture distance and the object position of the target object in the case where a capture distance between the target object and a capture apparatus satisfies a first distance condition.
S330, displaying at least part of an image content in the first image in the target image region to acquire an effect image.
S340, determining a target image region in the second image based on the capture distance and the object position of the target object when the capture distance satisfies a second distance condition;

Note that, in order to present the effect that the capture distance is associated with the effect of the effect image, the second distance condition may be set in advance to display the preset image content in the determined target image region in the case where the capture distance satisfies the second distance condition.

Here, the second distance condition may be understood as a preset effect processing triggering condition. The second distance condition may include any condition set according to the capture distance. Alternatively, the second distance condition may include a second capture distance range; alternatively, a second distance variation range may be included.

It should be noted that the technical solutions provided by the embodiments of the present disclosure may include only the first distance condition, only the second distance condition, and also include the first distance condition and the second distance condition, and in the case where the first distance condition and the second distance condition are included, at least one of the distance conditions may also be responded to according to a triggering operation set by a user, and this is not specifically limited by the embodiments of the present disclosure. With regard to the case including the first distance condition and the second distance condition, it can be seen from the above-mentioned disclosed embodiments that in the case where the capture distance satisfies the first distance condition, the image content displayed in the target image region is at least part of the image content in the first image, and the region size of the target image region becomes larger and larger as the capture distance between the target object in the first image and the capture apparatus gradually decreases. Based on the above-mentioned process, it can be shown that in the case where the first distance condition includes the first capture distance range and the second distance condition includes the second capture distance range, when the capture distance satisfies the first distance condition, the capture distance may first satisfy the second distance condition, and therefore, in the case where the first distance condition includes the first capture distance range, the second distance condition may also include the second capture distance range. In addition, the maximum value in the first capture distance range is smaller than the minimum value in the second capture distance range.

Also note that in the case where the first distance condition includes a first distance variation range, the second distance condition includes a second distance variation range. The first distance variation range and the second distance variation range are numerical ranges for defining a variation value of a capture distance in two frames of the first image. The first distance variation range and the second distance variation range may define the variation value of the capture distance in any two frames of the first image. Alternatively, the first distance variation range and the second distance variation range may be numerical ranges defining variation values of the capture distances in the two adjacent frames of the first images, i.e. defining differences between the capture distances in two adjacent frames of the first images. The minimum value of the first distance variation range may be the corresponding minimum value when the difference between the capture distances in two adjacent frames of the first images meets the first distance condition; the maximum value of the first distance variation range may be the maximum value corresponding to when the difference between the capture distances in two adjacent frames of the first images meets the first distance condition. The minimum value of the second distance variation range may be the corresponding minimum value when the between the capture distances in two adjacent frames of the first images meets the second distance condition; the maximum value of the second distance variation range may be the corresponding maximum value when the between the capture distances in two adjacent frames of the second images meets the second distance condition.

In practical applications, the variation value between the capture distances in any two frames of the first image can be regarded as the “strength” of the proximity of the target object to the capture apparatus, i.e. the greater the variation value, the greater the “strength”; the smaller the variation value, the smaller the “force”. Furthermore, it can be seen from the above-mentioned disclosed embodiments that when the capture distance satisfies the first distance condition, the capture distance may first satisfy the second distance condition, and therefore the first distance variation range may include the second distance variation range, that is, the minimum value in the first distance variation range is smaller than the maximum value in the second distance variation range.

Further, the region center point in the second image may be determined from the object position of the target object, and the target region parameter may be determined based on the capture distance. Thereafter, the region mask image may be determined based on the region center point and the target region parameters, and a target image region in the second image may be determined based on the region mask image and the second image.

S350, displaying the preset image content corresponding to the capture distance in the target image region to acquire an effect image.

Here, the preset image contents may be understood as image contents set in advance for displaying in a corresponding image region. The preset image content may be any image content and, alternatively, may be a preset texture image.

In practice, after the target image region is determined, the second image may be processed to remove the image content in the target image region in the second image. Further, it is possible to obtain the second image in which the target image region does not display any image content. Further, the preset image content may be displayed in the target image region in the second image. Thus, an effect image can be acquired.

A technical solution of an embodiment of the present disclosure, the first image and the second image are acquired by responding to an effect triggering operation, wherein the first image comprises a target object, and the second image is displayed on an upper layer of the first image. Further, in the case where it is detected that a capture distance between the target object and a capture apparatus satisfies a first distance condition, a target image region in the second image is determined based on the capture distance and the object position of the target object, and at least part of image content in the first image is displayed in the target image region to acquire an effect image. Further, in the case where the capture distance satisfies the second distance condition, a target image region in the second image is determined on the basis of the capture distance and the object position of the target object, the preset image content corresponding to the capture distance is displayed in the target image region to acquire an effect image, realizing the effects of respectively corresponding to different effect images under the conditions that the capture distance satisfies different distances, thereby enhancing the correlation degree between the effect props and the capture distance, enhancing the richness and interest of the effect images, and improving the user's experience of using the effect props.

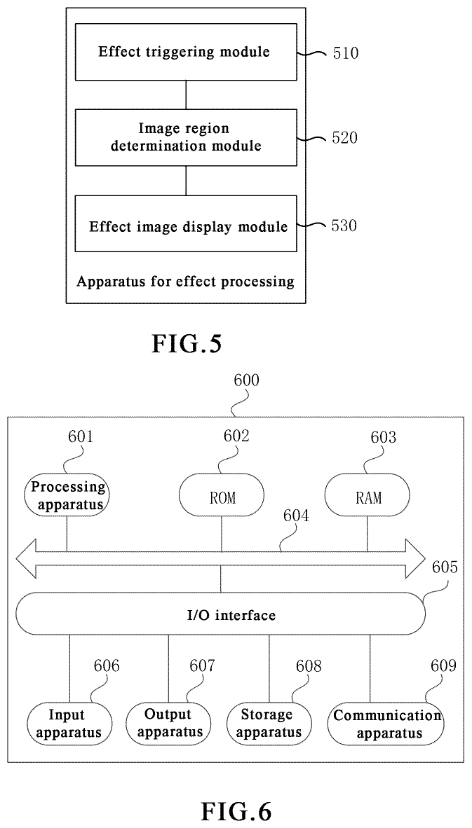

FIG. 5 illustrates a schematic view of a structure of an apparatus for effect processing in accordance with embodiments of the present disclosure. As shown in FIG. 5, the apparatus comprises: an effect triggering module 410, an image region determination module 420 and an effect image display module 430.

Here, the effect triggering module 410 is used for acquiring the first image and the second image in response to an effect triggering operation, wherein the first image comprises a target object, and the second image is displayed on an upper layer of the first image. The image region determination module 420 is used for determining a target image region in the second image based on the capture distance and the object position of the target object in the case where it is detected that the capture distance between the target object and the capture apparatus satisfies a first distance condition. The effect image display module 430 is used for displaying at least part of the image content in the first image in the target image region to acquire an effect image.

On the basis of the above-mentioned optional technical solutions, alternatively, the image region determination module 420 includes: a region parameter determination unit and an image region determination unit.

A region parameter determination unit is used for determining a region center point in the second image based on the object position of the target object and determining a target region parameter based on the capture distance, wherein the target region parameter comprises a region shape and/or a region size;

An image region determination unit is used for determining an region mask effect based on the region center point and the target region parameter, and determining a target image region in the second image based on the region mask effect and the second image.

On the basis of the above-mentioned optional technical solutions, alternatively, the region parameter determination unit includes: an identifier display subunit and an region parameter determination subunit.

The identifier display subunit is used for displaying at least one candidate region style identifier in response to a region setting triggering operation;

The region parameter determination subunit is used for determining a target region parameter based on a region style corresponding to the selected region style identifier and the capture distance, in response to a selection triggering operation for the region style identifier input.

On the basis of the above-mentioned optional technical solutions, alternatively, the effect image display module 430 comprises: an edge effect action unit.

The edge effect action unit is used for determining a region edge effect corresponding to the target image region, applying the region edge effect to the target image region, and displaying at least part of the image content in the first image in the target image region.

On the basis of the above-mentioned optional technical solutions, alternatively, the edge effect action unit comprises: an image fusion subunit.

The image fusion subunit is used for acquiring an edge mask image corresponding to the region edge effect, and performing image fusion on the edge mask image, the region mask image, the second image and the first image to acquire an effect image, wherein the region mask image is located at the upper layer of the edge mask image.

On the basis of the above-mentioned optional technical solutions, alternatively, the edge effect action unit comprises: an effect identifier display subunit and an edge effect determination subunit.

An effect identifier display subunit for displaying at least one candidate edge effect identifier in response to an edge setting triggering operation;

The edge effect determination subunit is used for, in response to a selection triggering operation input for the edge effect identifier, determining a region edge effect corresponding to the target image region based on the target region parameter corresponding to the target image region and the edge effect corresponding to the selected edge effect identifier.

On the basis of the above-mentioned optional technical solutions, alternatively, the device further includes: the object position acquisition module.

The object position acquisition module is used for acquiring a position where a target point of the target object is located as the object position before determining a target image region in the second image based on the object position of the target object, wherein the target point comprises a preset point and/or a geometric center point.

On the basis of the above-mentioned optional technical solutions, alternatively, the effect image display module 430 comprises: an image content subtraction unit.

The image content subtraction unit is used for dividing the image content in the target image region in the second image to display the image content in the first image in the target image region.

On the basis of the above-mentioned optional technical solutions, alternatively, the device further includes: a target image region determination module and an effect image generation module.

The target image region determination module is used for determining a target image region in the second image based on the capture distance and the object position of the target object in the case where the capture distance satisfies a second distance condition after acquiring the first image and the second image;

The effect image generation module is used for displaying preset image content corresponding to the capture distance in the target image region to acquire an effect image.

On the basis of the above-mentioned optional technical solutions, alternatively, in the case where the first distance condition comprises a first capture distance range, the second distance condition comprises a second capture distance range, and the maximum value in the first capture distance range is less than the minimum value in the second capture distance range; the first capture distance range and the second capture distance range are numerical ranges for defining a distance value of the capture distance; alternatively,

In the case where the first distance condition includes a first distance variation range and the second distance condition includes a second distance variation range, a minimum value in the first distance variation range is smaller than a maximum value in the second distance variation range; the first distance variation range and the second distance variation range are numerical ranges for defining a variation value of the capture distance in two frames of the first image.

On the basis of the above-mentioned optional technical solutions, alternatively, the effect triggering module 410 includes: the second image first acquisition unit or the second image second acquisition unit.

The second image first acquisition unit is used for acquiring the preset image as the second image; alternatively,

The second image second acquisition unit is used for processing the first image based on the preset image processing manner to obtain the second image, wherein the image processing manner comprises at least one of adding a grey filter, blurring processing, binarization processing and stylization processing.

According to the technical solution of the embodiments of the present disclosure, the first image and the second image are acquired by the effect triggering module in response to the effect triggering operation; since the second image is displayed on the upper layer of the first image, compared with the method of directly displaying the first image, the image display content before effect processing is enriched; furthermore, in the case where it is detected that the capture distance between the target object in the first image and the capture apparatus satisfies the first distance condition, the target image region in the second image is determined by the image region determination module based on the capture distance and the object position of the target object; the feature of the target object in the depth direction is applied to the effect processing through the capture distance, and the target image region is associated with the object position of the target object, which enriches the effect of the basic support data of the effect processing. Finally, at least part of the image content in the first image is displayed in the target image region through the effect image display module to acquire an effect image, which solves the technical problems in the related art, such as the single interaction mode of the effect props and the cumbersome production process, and so on; and applies the capture distance of the target object in the image to the effect processing to acquire the effect of effect images correlated with capture distance, increases the interaction between users and effect props, enhances the richness and interest of effect images, and improves the use experience of effect props.

The effect processing device provided by an embodiment of the present disclosure can execute the effect processing method provided by any embodiment of the present disclosure, and has functional modules and advantageous effects corresponding to the execution method.

It should be noted that the various units and modules comprised in the above-mentioned device are merely divided according to functional logic, but are not limited to the above-mentioned division, as long as the corresponding functions can be realized. In addition, the specific names of the functional units are also for the convenience of distinguishing each other and are not intended to limit the scope of the disclosed embodiments.

FIG. 6 illustrates a schematic view of a structure of an electronic device in accordance with embodiments of the present disclosure. Reference is next made to FIG. 6, which illustrates a block diagram of an electronic device (e.g. a terminal device or server in FIG. 6) 600 suitable for implementing embodiments of the present disclosure. The terminal device in the embodiment of the present disclosure may include, but is not limited to, a mobile terminal such as a mobile phone, a notebook computer, a digital broadcast receiver, a PDA (Personal Digital Assistant), a PAD (Tablet Computer), a PMP (Portable Multimedia Player), an in-vehicle terminal (e.g. an in-vehicle navigation terminal), etc. and a fixed terminal such as a digital TV, a desktop computer, etc. The electronic device shown in FIG. 6 is merely an example and should not impose any limitations on the functionality and scope of use of embodiments of the present disclosure.

As shown in FIG. 6, the electronic device 600 may include a processing device (e.g. central processing unit, graphics processor, etc.) 601 that may perform various suitable actions and processes in accordance with a program stored in a read only memory (ROM) 602 or a program loaded from a storage device 608 into a random access memory (RAM) 603. In the RAM 603, various programs and data required for the operation of the electronic device 600 are also stored. The processing device 601, the ROM 602, and the RAM 603 are connected to each other via a bus 604. An edit/output (I/O) interface 605 is also coupled to bus 604.

In general, the following devices may be connected to the I/O interface 605: an input device 606 including, for example, a touch screen, a touch pad, a keyboard, a mouse, a camera, a microphone, an accelerometer, a gyroscope, etc.; an output device 607 including, for example, a liquid crystal display (LCD), a speaker, a vibrator, and the like; a storage device 608 including, for example, a magnetic tape, a hard disk, etc.; and communication means 609. The communication means 609 may allow the electronic device 600 to communicate wirelessly or wired with other devices to exchange data. While FIG. 6 illustrates an electronic device 600 having various means, it is to be understood that not all illustrated means are required to be implemented or provided. Alternatively, More or fewer devices may be implemented or provided.

In particular, the processes described above with reference to flow diagrams may be implemented as computer software programs in accordance with embodiments of the present disclosure. For example, embodiments of the present disclosure include a computer program product comprising a computer program embodied on a non-transitory computer-readable medium, the computer program comprising program code for performing the method illustrated by the flowchart. In such embodiments, the computer program may be downloaded and installed from a network via the communication means 609, or from the storage means 608, or from the ROM 602. When the computer program is executed by the processing means 601, the above-described functions defined in the method of the embodiment of the present disclosure are performed.

The names of messages or information interacted between devices in embodiments of the present disclosure are for illustrative purposes only and are not intended to limit the scope of such messages or information.

The electronic device provided by the embodiments of the present disclosure belongs to the same inventive concept as the specific processing method provided by the above-mentioned embodiments, and technical details not described in detail in the embodiments of the present disclosure can be referred to the above-mentioned embodiments, and the present embodiments have the same advantageous effects as the above-mentioned embodiments.

Embodiments of the present disclosure provide a computer storage medium having stored thereon a computer program that, when executed by a processor, implements the method for effect processing provided by the above embodiments.

Note that the computer-readable medium described above in the present disclosure can be either a computer-readable signal medium or a computer-readable storage medium, or any combination of the two. The computer-readable storage medium can be, for example but not limited to, an electronic, magnetic, optical, electromagnetic, infrared, or semiconductor system, apparatus, or device, or a combination of any of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. In the present disclosure, a computer-readable signal medium may comprise a data signal embodied in baseband or propagated as part of a carrier wave carrying computer-readable program code. Such propagated data signals may take many forms, including but not limited to, electromagnetic signals, optical signals, or any suitable combination of the preceding. The computer-readable signal medium can also be any computer-readable medium other than a computer-readable storage medium that can send, propagate, or transport the program for use by or in connection with the instruction execution system, apparatus, or device. The program code embodied on the computer-readable medium may be transmitted over any suitable medium including, but not limited to: wire, fiber optic cable, RF (radio frequency), and the like, or any suitable combination of the foregoing.

In some embodiments, clients, servers may communicate using any currently known or future developed network protocol, such as HTTP (Hyper Text Transfer Protocol), and may be interconnected with any form or medium of digital data communication (e.g. a communication network). Examples of communication networks include local area networks (“LANs”), wide area networks (“WANs”), internetworks (e.g. the Internet), and peer-to-peer networks (e.g. ad hoc peer-to-peer networks), as well as any currently known or future developed networks.

The computer-readable medium may be contained in the electronic device; it may also be present separately and not fitted into the electronic device.

The computer-readable medium carries one or more programs that, when executed by the electronic device, cause the electronic device to: in response to an effect triggering operation, acquire the first image and the second image, wherein said first image comprises a target object, and said second image is displayed on an upper layer of said first image; determine a target image region in the second image based on the capture distance and the object position of the target object in the case where the capture distance between the target object and the camera satisfies a first distance condition; display at least part of the image content in said first image in said target image region to obtain an effect image.

Computer program code for carrying out operations of the present disclosure may be written in one or more programming languages, including, but not limited to, object oriented programming languages, such as Java, Smalltalk, C++, and conventional procedural programming languages, such as the “C” language or similar programming languages, or a combination thereof. The program code may execute entirely on the user's computer, partly on the user's computer, as a stand-alone software package, partly on the user's computer partly on a remote computer or entirely on the remote computer or server. In the case of a remote computer, the remote computer may be connected to the user's computer through any kind of network, including a local area network (LAN) or a wide area network (WAN), or it may be connected to an external computer (e.g. through the Internet using an Internet Service Provider).

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems which perform the specified functions or operations, or combinations of special purpose hardware and computer instructions.

The elements described in connection with the embodiments disclosed herein may be implemented in software or hardware. Where the name of the unit does not in some cases constitute a limitation on the unit itself, for example, the first acquisition unit may also be described as “a unit acquiring at least two internet protocol addresses”.

The functions described herein above may be performed, at least in part, by one or more hardware logic components. For example, without limitation, exemplary types of hardware logic components that may be used include: field Programmable Gate Arrays (FPGAs), application Specific Integrated Circuits (ASICs), application Specific Standard Products (ASSPs), systems on a Chip (SOCs), complex Programmable Logic Devices (CPLDs), and the like.

In the context of the present disclosure, a machine-readable medium can be a tangible medium that can contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the preceding. More specific examples of a machine-readable storage medium would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the preceding.

According to one or more embodiments of the present disclosure, [Example 1] provides an effect processing method, comprising:
in response to an effect triggering operation, obtaining the first image and the second image, wherein the first image comprises a target object, and the second image is displayed on an upper layer of the first image;
determining a target image region in the second image based on the capture distance and the object position of the target object in the case where a capture distance between the target object and a capture apparatus satisfies a first distance condition;
displaying at least part of an image content in the first image in the target image region to acquire an effect image.

According to one or more embodiments of the present disclosure, [Example 2] provides the method of Example 1, further comprising:

Alternatively, determining a target image region in the second image based on the capture distance and the object position in the target object comprises: determining a region center point in the second image based on the object position of the target object and determining a target region parameter based on the capture distance, wherein the target region parameter at least comprises a region size; determining the region mask image based on the region center point and the target region parameter, and determining a target image region in the second image based on the region mask image and the second image.

According to one or more embodiments of the present disclosure, [Example 3] provides the method of Example 2, further including:

Alternatively, the determining a target region parameter based on the capture distance comprises:
in response to a region setting triggering operation, displaying at least one candidate region style identifier;
in response to a selection triggering operation for the region style identifier input, determining a target region parameter based on a region style corresponding to the selected region style identifier and the capture distance.

In accordance with one or more embodiments of the present disclosure, [Example 4] provides the method of Example 1 or Example 2, further including:

Alternatively, the displaying at least part of an image content in the first image in the target image region comprises: determining a region edge effect corresponding to the target image region, applying the region edge effect to the target image region, and displaying at least part of an image content in the first image in the target image region.

According to one or more embodiments of the present disclosure, [Example 5] provides the method of Example 4, further including:
Alternatively, the applying the region edge effect to the target image region, and displaying at least part of an image content in the first image in the target image region comprises: acquiring an edge mask image corresponding to the region edge effect, and determining an effect image based on the edge mask image, the region mask image, the second image and the first image, wherein the region mask image is located at an upper layer of the edge mask image.

According to one or more embodiments of the present disclosure, [Example 6] provides the method of Example 4, further including:

Alternatively, the determining a region edge effect corresponding to the target image region comprises: displaying at least one candidate edge effect identifier in response to an edge setting triggering operation; in response to a selection triggering operation for the edge effect identifier input, determining a region edge effect corresponding to the target image region based on a target region parameter corresponding to the target image region and a region edge effect corresponding to the selected edge effect identifier.

According to one or more embodiments of the present disclosure, [Example 7] provides the method of Example 1, further including: before the determining a target image region in the second image based on the capture distance and the object position in the target object further comprises: acquiring a position where a target point of the target object is located as the object position, wherein the target point comprises a preset point and/or a geometric center point.

Alternatively, according to one or more embodiments of the present disclosure, [Example 8] provides the method of Example 1, further including:

Alternatively, the displaying at least part of an image content in the first image in the target image region comprises: erasing an image content in the target image region in the second image to display at least part of an image content in the first image in the target image region.

According to one or more embodiments of the present disclosure, [Example 9] provides the method of Example 1, further including:

Alternatively, after acquiring the first image and the second image further comprises: determining a target image region in the second image based on the capture distance and the object position of the target object when the capture distance satisfies a second distance condition; displaying the preset image content corresponding to the capture distance in the target image region to acquire an effect image.

According to one or more embodiments of the present disclosure, [Example 10] provides the method of Example 9, further including:

Alternatively, in the case where the first distance condition includes a first capture distance range, the second distance condition includes a second capture distance range, and a maximum value in the first capture distance range is smaller than a minimum value in the second capture distance range; the first capture distance range and the second capture distance range are numerical ranges for defining a distance value of the capture distance; or, in the case where the first distance condition includes a first distance variation range and the second distance condition includes a second distance variation range, a minimum value in the first distance variation range is smaller than a maximum value in the second distance variation range; the first distance variation range and the second distance variation range are numerical ranges for defining a variation value of the capture distance in two frames of the first image.

According to one or more embodiments of the present disclosure, [Example 11] provides the method of Example 1, further including:

Alternatively, the acquiring the second image comprises: acquiring the preset image as the second image; or, processing the first image based on the preset image processing manner to acquire the second image, wherein the image processing manner comprises at least one of adding a grey filter, a blurring processing, a binarization processing and a stylization processing.

According to one or more embodiments of the present disclosure, [Example 12] provides an effect treatment apparatus, including:
an effect triggering module for acquiring the first image and the second image in response to an effect triggering operation, wherein the first image comprises a target object, and the second image is displayed on an upper layer of the first image;
an image region determination module for determining a target image region in the second image based on the capture distance and the object position of the target object in the case where a capture distance between the target object and a capture apparatus is detected to satisfy a first distance condition;
an effect image display module for displaying at least part of an image content in the first image in the target image region to acquire an effect image.

The foregoing description is only a preferred embodiment of the disclosure and is illustrative of the principles of the technology employed. It will be appreciated by those skilled in the art that the scope of the present disclosure is not limited to any particular combination of the features described above, but is intended to encompass any combination of the features described above or their equivalents without departing from the spirit of the disclosure. For example, the above-mentioned features and the technical features disclosed in the present disclosure (but not limited to) having similar functions are interchanged to form a technical solution.

Further, while operations are depicted in a particular order, this should not be understood as requiring that the operations be performed in the particular order shown or in sequential order. In certain circumstances, multitasking and parallel processing may be advantageous. As such, while several specific implementation details have been included in the above discussion, these should not be construed as limiting the scope of the present disclosure. Certain features that are described in the context of separate embodiments may also be implemented in combination in a single embodiment. Conversely, various features that are described in the context of a single embodiment can also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

I/We claim:

1. A method for effect processing comprising:
obtaining, in response to an effect triggering operation, a first image and a second image, wherein the first image comprises a target object, and the second image is displayed on top of the first image;
determining, in response to that a capture distance between the target object and a capture apparatus satisfies a first distance condition, a target image region in the second image based on the capture distance and an object position of the target object; and
displaying, in the target image region, at least part of an image content in the first image to acquire an effect image.

2. The method of claim 1, wherein the determining a target image region in the second image based on an object position of the target object comprises:
determining a region center point in the second image based on an object position of the target object, and determining a target region parameter based on the capture distance, wherein the target region parameter at least comprises a region size; and
determining a region mask image based on the region center point and the target region parameter, and determining a target image region in the second image based on the region mask image and the second image.

3. The method of claim 2, wherein the determining a target region parameter based on the capture distance comprises:
displaying, in response to a region setting triggering operation, at least one candidate region style identifier;
determining, in response to a selection triggering operation for the region style identifier input, a target region parameter based on a region style corresponding to a selected region style identifier and the capture distance.

4. The method of claim 1, wherein the displaying, in the target image region, at least part of an image content in the first image comprises:
determining a region edge effect corresponding to the target image region, applying the region edge effect to the target image region, and displaying at least part of an image content in the first image in the target image region.

5. The method of claim 4, wherein the applying the region edge effect to the target image region and displaying at least part of an image content in the first image in the target image region comprise:
acquiring an edge mask image corresponding to the region edge effect, and determining an effect image based on the edge mask image, the region mask image, the second image and the first image, wherein the region mask image is located on top of the edge mask image.

6. The method of claim 4, wherein the determining a region edge effect corresponding to the target image region comprises:
displaying at least one candidate edge effect identifier in response to an edge setting triggering operation; and
in response to a selection triggering operation for the edge effect identifier input, determining the region edge effect corresponding to the target image region based on a target region parameter corresponding to the target image region and the region edge effect corresponding to the selected edge effect identifier.

7. The method of claim 1, the method further comprising, before determining a target image region in the second image based on the capture distance and an object position in the target object,
acquiring a position of a target point of the target object as an object position, wherein the target point comprises a preset point and/or a geometric center point.

8. The method of claim 1, wherein the displaying, in the target image region, at least part of an image content in the first image comprises:
removing an image content in the target image region in the second image to display at least part of an image content in the first image in the target image region.

9. The method of claim 1, the method further comprising: after obtaining the first image and the second image:
determining, in response to that the capture distance satisfies a second distance condition, a target image region in the second image based on the capture distance and the object position of the target object; and
displaying, in the target image region, a preset image content corresponding to the capture distance to acquire an effect image.

10. The method for effect processing of claim 9, wherein
the first distance condition includes a first capture distance range, the second distance condition includes a second capture distance range, and a maximum value in the first capture distance range is smaller than a minimum value in the second capture distance range; the first capture distance range and the second capture distance range are numerical ranges for defining a distance value of the capture distance; or,
the first distance condition includes a first distance variation range and the second distance condition includes a second distance variation range, a minimum value in the first distance variation range is smaller than a maximum value in the second distance variation range; the first distance variation range and the second distance variation range are numerical ranges for defining a variation value of the capture distance in two frames of the first image.

11. The method of claim 1, wherein the obtaining the second image comprises:
acquiring a preset image as a second image; or,
processing the first image based on a preset image processing manner to obtain a second image, wherein the preset image processing comprises at least one of adding a grey filter, blurring processing, binarization processing and stylization processing.

12. An electronic device comprising:
one or more processors; and
a storage device for storing one or more programs,
wherein the one or more programs, when executed by the one or more processors, cause the one or more processors to:
obtain, in response to an effect triggering operation, a first image and a second image, wherein the first image comprises a target object, and the second image is displayed on top of the first image;
determine, in response to that a capture distance between the target object and a capture apparatus satisfies a first distance condition, a target image region in the second image based on the capture distance and an object position of the target object; and
display, in the target image region, at least part of an image content in the first image to acquire an effect image.

13. The device of claim 12, wherein the one or more programs causing the one or more processors to determine a target image region in the second image based on an object position of the target object comprise instructions to:
determine a region center point in the second image based on an object position of the target object, and determining a target region parameter based on the capture distance, wherein the target region parameter at least comprises a region size; and
determine a region mask image based on the region center point and the target region parameter, and determining a target image region in the second image based on the region mask image and the second image.

14. The device of claim 13, wherein the one or more programs causing the one or more processors to determine a target region parameter based on the capture distance comprise instructions to:
display, in response to a region setting triggering operation, at least one candidate region style identifier;
determine, in response to a selection triggering operation for the region style identifier input, a target region parameter based on a region style corresponding to a selected region style identifier and the capture distance.

15. The device of claim 12, wherein the one or more programs causing the one or more processors to display, in the target image region, at least part of an image content in the first image comprise instructions to:
determine a region edge effect corresponding to the target image region, applying the region edge effect to the target image region, and displaying at least part of an image content in the first image in the target image region.

16. The device of claim 15, wherein the one or more programs causing the one or more processors to apply the region edge effect to the target image region and displaying at least part of an image content in the first image in the target image region comprise instructions to:
acquire an edge mask image corresponding to the region edge effect, and determining an effect image based on the edge mask image, the region mask image, the second image and the first image, wherein the region mask image is located on top of the edge mask image.

17. The device of claim 15, wherein the one or more programs causing the one or more processors to determine a region edge effect corresponding to the target image region comprise instructions to:
display at least one candidate edge effect identifier in response to an edge setting triggering operation; and
in response to a selection triggering operation for the edge effect identifier input, determine the region edge effect corresponding to the target image region based on a target region parameter corresponding to the target image region and the region edge effect corresponding to the selected edge effect identifier.

18. The device of claim 12, wherein the one or more programs further cause the one or more processors to, before determining a target image region in the second image based on the capture distance and an object position in the target object,
acquire a position of a target point of the target object as an object position, wherein the target point comprises a preset point and/or a geometric center point.

19. The device of claim 12, wherein the one or more programs causing the one or more processors to display, in the target image region, at least part of an image content in the first image comprise instructions to:
remove an image content in the target image region in the second image to display at least part of an image content in the first image in the target image region.

20. A non-transitory storage medium containing computer-executable instructions, when executed by a computer processor, the computer-executable instructions cause the computer processor to:
obtain, in response to an effect triggering operation, a first image and a second image, wherein the first image comprises a target object, and the second image is displayed on top of the first image;
determine, in response to that a capture distance between the target object and a capture apparatus satisfies a first distance condition, a target image region in the second image based on the capture distance and an object position of the target object; and
display, in the target image region, at least part of an image content in the first image to acquire an effect image.
